(19) United States
(12) Patent Application Publication
(10) Pub. No.: US 2026/0149009 A1
(43) Pub. Date: May 28, 2026

(54) GAS DIFFUSION LAYER WITH LOW PLASTIC DEFORMABILITY AND HIGH SURFACE QUALITY, AND METHOD FOR ITS PRODUCTION

(71) Applicant: Carl Freudenberg KG, Weinheim (DE)

(72) Inventors: Achim BOCK, Weinheim (DE); Kristof KLEIN, Weinheim (DE); Christoph RAKOUSKY, Ober-Ramstadt (DE); Hannes BARSCH, Heidelberg (DE); Matthias LÖBLE, Mannheim (DE); Amélie VON SPEE, Mannheim (DE)

(21) Appl. No.: 19/120,810

(22) PCT Filed: Oct. 11, 2023
(86) PCT No.: PCT/EP2023/078170

§ 371 Date: Apr. 14, 2025

(30) Foreign Application Priority Data
Oct. 18, 2022 (DE) 10 2022 127 234.6

(51) Int. Cl. H01M 8/0245; H01M 8/0234; H01M 8/0239; H01M 8/0243; H01M 8/10; H01M 8/1004

(52) U.S. Cl. CPC H01M 8/0245; H01M 8/0234; H01M 8/0239; H01M 8/0243; H01M 8/1004; H01M 2008/1095

(57) ABSTRACT

The present invention relates to a method for producing a gas diffusion layer for a fuel cell, the gas diffusion layer having low plastic deformability (low setting behavior) and good surface quality. The invention also relates to the gas diffusion layers obtainable according to the method and to a fuel cell that contains such a gas diffusion layer.

### CROSS REFERENCE TO RELATED APPLICATIONS

This application is a U.S. National Phase application under 35 U.S.C. § 371 of International Application No. PCT/EP2023/078170, filed on Oct. 11, 2023, and claims benefit to German Patent Application No. DE 10 2022 127 234.6, filed on Oct. 18, 2022. The International Application was published in German on Apr. 25, 2024 as WO 2024/083601 A1 under PCT Article 21(2).

### FIELD

The present disclosure relates to a method for producing a gas diffusion layer for a fuel cell, the gas diffusion layer having low plastic deformability (low setting behavior) and good surface quality. The present disclosure describes the gas diffusion layers obtainable according to this method and to a fuel cell that contains such a gas diffusion layer.

### BACKGROUND

Fuel cells use the chemical reaction of a fuel, in particular hydrogen, with oxygen to form water in order to generate electrical energy. In hydrogen-oxygen fuel cells, hydrogen or a hydrogen-containing gas mixture is fed to the anode, where an electrochemical oxidation occurs, releasing electrons (H₂→2 H⁺+2 e⁻). The protons are transported from the anode chamber to the cathode chamber through a membrane, which separates the reaction chambers in a gas-tight manner and electrically insulates them. The electrons provided at the anode are conducted to the cathode via an external conductive circuit. Oxygen or an oxygen-containing gas mixture is fed to the cathode, whereby the oxygen is reduced, accepting electrons. The oxygen anions thus formed react with protons transported through the membrane, forming water (½ O₂+2 H⁺+2 e⁻→H₂O).

For many applications, especially in the automotive drive train, low-temperature proton exchange membrane fuel cells (PEMFC, also called polymer electrolyte membrane fuel cells) are used, the heart of which is a polymer electrolyte membrane (PEM), which is permeable only to protons (or oxonium ions H₃O⁺) and water, and which spatially separates the oxidation agent, generally atmospheric oxygen, from the reducing agent. A catalyst layer is deposited on the gas-tight, electrically-insulating, proton-conducting membrane on the anode and cathode sides, the catalyst layer producing the electrodes and usually containing platinum as the catalytically active metal. The actual redox reactions and charge separations occur in the catalyst layers. The membrane and the catalytic layers form a unit, also referred to as CCM (catalyst coated membrane). A gas diffusion layer (GDL) is provided on both sides of the CCM, which stabilizes the cell structure and performs transport and distribution functions for reaction gases, water, heat and current. The membrane, electrodes and gas diffusion layer form the membrane-electrode assembly (MEA). Flow distribution plates (known as bipolar plates) are arranged between the membrane electrode assemblies. The flow distribution plates have channels for feeding the adjacent cathode and anode with process gases, and usually also have internal cooling channels.

Gas diffusion layers for fuel cells are typically made of a carbon fiber substrate, which is usually hydrophobically finished with fluoropolymers (e.g., PTFE) and then coated with a microporous layer (MPL) over their entire surface. The MPL is usually made of a fluorine-containing polymer as a binder (e.g., PTFE) and an electrically conductive material such as carbon black or graphite powder. The gas diffusion layers are of fundamental importance for the function and performance of the fuel cell. They are used, firstly, to transport the consumed and produced process components, and secondly, to conduct the electrons produced and consumed in the half-cell reactions and the heat generated during the reaction to the flow distribution plates. In addition, the GDL must also provide for mechanical compensation between the macrostructured flow distribution plate and the catalyst layers. To this end, it is necessary to compensate for component tolerances and to distribute the compression pressure. The GDL also serves to mechanically protect the very thin membranes, which are exposed to high loads in the fuel cells. The delicate membranes should, to the extent possible, not be damaged by the gas diffusion layer and its components. Therefore, high demands are placed on the mechanical properties and the surface properties of the GDL.

A great problem of fiber-based gas diffusion layers is that the membrane of the fuel cell can potentially be damaged by an inhomogeneous surface of the gas diffusion layer or by protruding fibers. These fibers are usually very stiff and brittle. Moreover, the fiber thickness is often on the order of the thickness of the fuel cell membrane, so that there is a risk of fibers penetrating the membrane, causing a short circuit. In the worst case, a short circuit caused by fibers penetrating the membrane can lead to failure of the entire fuel cell stack. Other error sources that can lead to similar failures or to a considerable decrease in the life of the stack are, for example, a very rough surface of the MPL or impurities of different hardness incorporated in the MPL. Since the membrane is subject to considerable mechanical stress during operation, the stack may also fail at a later time.

The membrane of a fuel cell is very thin, usually a few μm thick. Typical thicknesses are in a range of from 8 to 50 μm. However, some tests are already being conducted with membranes having thicknesses of 5 μm. It is expected that with the increasing use of fuel cells in automotive applications, there is a need to further reduce the thickness of all flat components (membranes, GDL/MPL, others). A very substantial performance problem is caused by internal short circuits, which can be caused by fibers protruding from the GDLs on the membrane. There is therefore a need to avoid protruding fibers and/or to smooth the MPL surfaces of the GDL.

GDLs are generally strongly compressed when used in fuel cells. The properties of GDLs resulting from compression can be characterized by the proportion of elastic and plastic deformation. In the case of plastic deformation, the gas diffusion layer does not return one hundred percent to its original shape after being loaded, but some permanent deformation will remain. The property of a material to permanently change its shape when subjected to stress, i.e., its deformability, is also referred to by the term “setting.” Materials with low plastic deformability have a low setting behavior. The setting behavior of the GDLs known from the prior art still needs to be improved. If the GDL is compressed under high pressures in the fuel cell stack, the clamping forces and dynamic force changes result in setting during operation. This can lead to a loss of compression pressure in the fuel cell stack, increasing the resistance of the material of most of the components and, above all, their contact resistance within the stack. Furthermore, the stack design may need to be adapted, for example, through the use of additional spring packs to compensate for the loss of clamping stress occurring during setting. This may increase the length of the stack and the space needed for its installation. Furthermore, additional measures may become necessary during stack assembly. For example, the stacks may be compressed and relieved multiple times during assembly before they are fixed, which increases the complexity of manufacture.

The development of fuel cells for everyday use is an important contribution to the energy transition from fossil to sustainable fuels. Therefore, there is currently a great demand for PEM fuel cells which are improved with respect to the above-described complex property profile.

It is known that the operational properties of fuel cells can be adjusted by using gas diffusion layers which have a gradient with respect to at least one physical or chemical property. WO 2022/002932 A1 describes a gas diffusion layer for a fuel cell, where at least one physical property selected from hydrophobicity and permeability varies in at least one direction along the largest planar dimension. Specifically, the disclosure proposes, for example, to control the hydrophobicity via the content of a hydrophobizing material (such as PTFE) and to control the permeability via the porosity of the gas diffusion layer. It is possible to control the thickness of the deposited microporous layer, which, inter alia, results in a varying local depth of penetration into the substrate. The disclosure of this application is not very specific and lacks information about the implementation of the described concepts as well as a practical exemplary embodiment and application technical data.

EP 3957789 A1 describes a gas diffusion layer which, despite having low density, has a high thermal conductivity, is easy to handle, and provides good cell performance. The GDL includes a carbon fiber felt containing carbon fibers having an average fiber diameter of 5 to 20 μm. At least a part of the carbon fibers that constitute the carbon fiber felt have a flat part in which, in a plane view of a surface of the carbon fiber felt, a maximum value of a fiber diameter is observed to be 10 to 50% larger than the average fiber diameter, and the frequency of the flat parts at the surface of the carbon fiber felt is 50 bis 200/mm².

WO 2020/165075 A1 describes a method for the preparation of a gas diffusion layer including the following steps:
a) preparing a carrier-binder paste containing a solvent, a fluorinated binder and conductive carrier particles;
b) preparing an adhesive composition including
   a solvent,
   a fluorinated binder, and
   essentially no or equal to or less than 15 wt % of conductive carrier particles, based on the total weight of fluorinated binder and any conductive carrier particles; and
c) combining a layer of supporting material, a layer of the adhesive composition and a layer of the carrier-binder paste, wherein the layer of the adhesive composition is applied between the layer of supporting material and the layer of the carrier-binder paste, and pressing the combination of supporting material, adhesive composition and carrier-binder paste at a pressure of at least 15 kilopascal and/or heating the combination of supporting material, adhesive composition and carrier-binder paste at a temperature of at least 300° C.

### SUMMARY

In an embodiment, the present disclosure provides a method for producing a gas diffusion layer for a fuel cell including: A) a flat, electrically conductive fiber material; and B) a microporous layer on at least one of the surfaces of the fiber material, where the microporous layer includes conductive particles in a matrix of a polymeric binding agent. The flat, electrically conductive fiber material A) is provided, and the fiber material is coated with a precursor to form the microporous layer. The coated fiber material is subjected to a post-treatment at elevated pressure and/or an elevated temperature.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a puncture testing device for determining the shorting number as a measurement value characterizing the probability of a short circuit;

FIG. 2 shows the plastic deformation properties (setting behavior) based on the compression set values at 1 MPa for 5 pairs of a reference GDL (left bar) and a GDL according to the present disclosure (right bars);

FIG. 3a shows the average roughness Rₐ (MD) determined using the profile method, as described in DIN 4768-1:1974-08, for 2 pairs of a reference GDL (left bar) and a GDL according to the present disclosure (right bars);

FIG. 3b shows the average roughness Rₐ (CD) determined using the profile method, as described in DIN 4768-1:1974-08, for 2 pairs of a reference GDL (left bar) and a GDL according to the present disclosure (right bars);

FIG. 4a shows the mean peak-to-valley height R_{z} (MD) determined using the profile method, as described in DIN 4768-1:1974-08, for 2 pairs of a reference GDL (left bar) and a GDL according to the present disclosure (right bars); and

FIG. 4b shows the mean peak-to-valley height R_{z} (CD) determined using the profile method, as described in DIN 4768-1:1974-08, for 2 pairs of a reference GDL (left bar) and a GDL according to the present disclosure (right bars).

### DETAILED DESCRIPTION

The present disclosure describes providing gas diffusion electrodes that are mechanically stable and where the carrier-binder layer, which is preferably in the form of a microporous layer, is firmly attached to the supporting material. This is achieved by the additional adhesive layer, which is free of electrical conductive particles or contains only a small amount thereof. The pressing of the layers is carried out at a pressure of no greater than 2.5 MPa and a temperature of at least 300° C., using long processing times of at least 15 minutes and preferably from 1 to 4 hours. The additional binder layer between the substrate and the MPL increases the number of required process steps and, in addition, severely hinders the industrial applicability.

JP 2007242378 A describes a gas diffusion layer composed of porous sintered carbon particles and water-repellent particles. In order to produce the gas diffusion layer, carbon particles and water repellent particles are dispersed in water in the presence of a nonionic surfactant and concentrated and sintered, with the phases being inverted. This sintered film is removed, re-pulverized, and the resulting sintered coarse particles are hot-pressed in a mold to form a GDL. This makes it possible to dispense with a fiber-based substrate in the final GDL, if desired, so that the GDL is composed solely of coarse carbon-based particles and water-repellent particles. Such an approach is likely to lead to disadvantages during the further processing, cutting, and production of the cell stack, as well as in terms of the stability in the cell.

EP 3276718 A1 describes a porous carbon electrode substrate that hardly causes a short circuit when used in a fuel cell. Carbon fibers that protrude from the substrate surface, or are caused to protrude from the substrate surface, when the porous carbon electrode substrate is pressurized, as well as short carbon fibers which are insufficiently bonded at the substrate surface are sufficiently removed. For production purposes, short carbon fibers and a binder resin are used. The binder resin has a carbon content of at least 35 wt % and carbonizes when heated. Thus, the resulting GDL substrate is based on a fiber material that is thoroughly impregnated with resin.

EP 3396753 A1 describes a gas diffusion layer that is less susceptible to the occurrence of a short circuit current when used in a fuel cell. The GDL substrate includes carbon short fibers bonded by a carbon resin, the gas diffusion electrode having a multi-layer configuration, preferably including at least two microporous layers that differ in their layer filling rate. The microporous layer(s) must have a sufficient thickness under compression. To reduce the probability of short circuits, a variety of measures are described, such as pressure treatment of the precursor substrate prior to carbonization of the binder resin, and increasing the temperature in the carbonization step. A subsequent calendering treatment, followed by blowing and suction of air, is described only for the case that a further reduction is desired. This method has the disadvantage that a pressure treatment prior to carbonization involves additional complexity, that resin binders are often not desired in the substrate, and moreover, that the use of two or more MPL layers increases complexity. In addition, a multi-layer configuration always increases the risk of delamination during winding, twisting, stretching, or under the action of pressure.

US 2019/0344405 describes a bonding device for bonding a gas diffusion layer within a fuel cell. This device has a suction device and is designed to bind or remove fluffy or loose fibers of a gas diffusion layer. The use of an additional device increases the production costs. Moreover, it is questionable whether the use of this device solves the problem of internal short circuits caused by fibers protruding from the GDLs on the membrane.

The present disclosure overcomes or reduces the above-described disadvantages.

Surprisingly, it was found that gas diffusion layers having a good property profile and, specifically, excellent surface properties and a significantly improved setting behavior can be obtained by subjecting the gas diffusion layer to a post-treatment at elevated pressure and elevated temperature. Hot-compacted gas diffusion layers are characterized in particular by a significantly smoother surface on the side(s) that is/are coated with a microporous layer. This significantly reduces the probability of short circuits caused by protruding fibers and impurities present at the surface of the MPL, by other causes of a rough surface, or by other effects that occur during the operation of the fuel cell and which can cause penetration of the membrane. Furthermore, the post-treatment at elevated pressure and elevated temperature can significantly reduce the proportion of plastic deformation of the GDL. It was also surprisingly found that the transport properties of the GDL can be controlled by means of the post-treatment. Thus, properties such as the permeability to gas and the dry diffusion length, can be controlled independently of the material composition of the gas diffusion layer.

A first aspect of the present disclosure includes a method for producing a gas diffusion layer for a fuel cell including:
A) a flat, electrically conductive fiber material; and
B) a microporous layer on at least one of the surfaces of the fiber material, the microporous layer including conductive particles in a matrix of a polymeric binding agent,
wherein:
i) a flat, electrically conductive fiber material A) is provided,
ii) the fiber material provided in step i) is coated with a precursor to form a microporous layer,
iii) the coated fiber material obtained in step ii) is subjected to a post-treatment at elevated pressure and possibly elevated temperature.

In embodiments the post-treatment in step iii), yields a gas diffusion layer having reduced deformability compared to a non-post-treated gas diffusion layer. In particular, a gas diffusion layer is obtained whose compression set value is reduced compared to a non-post-treated gas diffusion layer.

In embodiments the post-treatment in step iii), yields a gas diffusion layer whose at least one microporous layer has a smoother surface.

In an embodiment, the post-treatment in step iii) is carried out at an elevated pressure of at least 0.5 MPa and an elevated temperature of at least 100° C.

An embodiment of the present disclosure includes a method for obtaining a gas diffusion layer having one, preferably two, particularly preferably three, in particular four of the following properties:
a compression set value at 1.0 MPa of no greater than 5 μm, determined on a GDL having a weight per unit area of from 95 to 100 g/m² and an MPL loading of from 15 to 22 g/m² on an annular sample having an inner diameter of 45 mm and an outer diameter of 56 mm, the sample being subjected to three load cycles from 0.025 MPa to 1.0 MPa, and the compression set value being calculated from the difference between the thickness measured at 1.0 MPa in the first load cycle and in the third load cycle,
a decrease of at least 10% in the average roughness Rₐ, determined according to DIN EN ISO 4288:1998-04 using the profile method, compared to a non-post-treated gas diffusion layer,
a decrease of at least 10% in the mean peak-to-valley height R_{z}, determined according to DIN EN ISO 4288:1998-04 using the profile method, compared to a non-post-treated gas diffusion layer,
a shorting number of no greater than 25%, determined by a puncture test on a GDL having a planar area of 297×420 mm, a weight per unit area of 95 g/m², and an MPL loading of 15 g/m².

An embodiment of the present disclosure includes a gas diffusion layer obtainable by a method as described herein.

An embodiment of the present disclosure includes a gas diffusion layer for a fuel cell, including:
A) a flat, electrically conductive fiber material; and
B) a microporous layer on at least one of the surfaces of the fiber material, the gas diffusion layer having at least one of the following properties:
   a compression set value at 1.0 MPa of no greater than 5 μm, determined on a GDL having a weight per unit area of from 95 to 100 g/m² and an MPL loading of from 15 to 22 g/m² on an annular sample having an inner diameter of 45 mm and an outer diameter of 56 mm, the sample being subjected to three load cycles from 0.025 MPa to 1.0 MPa, and the compression set value being calculated from the difference between the thickness measured at 1.0 MPa in the first load cycle and in the third load cycle,
   a decrease of at least 10% in the average roughness Rₐ, determined according to DIN EN ISO 4288:1998-04 using the profile method, compared to a non-post-treated gas diffusion layer,
   a decrease of at least 10% in the mean peak-to-valley height R_{z}, determined according to DIN EN ISO 4288:1998-04 using the profile method, compared to a non-post-treated gas diffusion layer,
   a shorting number of no greater than 25%, determined by a puncture test on a GDL having a planar area of 297×420 mm, a weight per unit area of 95 g/m², and an MPL loading of 15 g/m².

An embodiment of the present disclosure includes a fuel cell including at least one gas diffusion layer as defined herein.

An embodiment of the present disclosure includes the use of a gas diffusion layer as defined herein, or obtainable by a method as defined herein, in a proton exchange membrane fuel cell.

The novel gas diffusion layers obtained using the method of the present disclosure has the following advantages:
The gas diffusion layers obtained have excellent surface properties. Gas diffusion layers which are post-treated at elevated pressure and preferably elevated temperature are characterized in particular by a significantly smoother surface on the side(s) that is/are coated with a microporous layer.
The gas diffusion layers have a significantly reduced probability of short circuits caused by penetration of the proton exchange membrane, such as may be caused in particular by protruding fibers, impurities present at the surface of the MPL, or by other causes of a rough surface.
The gas diffusion layers have a significantly improved setting behavior. The inventive post-treatment at elevated pressure and preferably elevated temperature can significantly reduce the proportion of plastic deformation of the GDL.
Design measures to adapt the fuel cell stack to the consequences associated with the setting of the GDL, such as a reduced compression pressure, increased resistance of the material of the assembled components, as well as a loss of clamping stress, can be reduced or completely eliminated.
Surprisingly, it was found that the transport properties of the gas diffusion layer can also be controlled in a targeted manner by means of the post-treatment. Thus, properties such as the permeability to gas and the dry diffusion length, can be controlled independently of the material composition of the gas diffusion layer.
The gas diffusion layers according to the present disclosure are easy and inexpensive to produce.

A method according to the present disclosure includes the following steps:
i) providing a flat, electrically conductive fiber material A),
ii) coating the fiber material provided in step i) with a precursor to form a microporous layer B), the composition of the precursor being varied to create a gradient,
iii) subjecting the fiber material obtained in step ii) to a post-treatment at elevated pressure and possibly elevated temperature.

As for the fiber materials A) and the precursors and conditions for forming a microporous layer B), reference is made to the explanations given herein in their entirety.

### Post-Treatment at Elevated Pressure and at Elevated Temperature

In an embodiment, the post-treatment in step iii) is carried out at an elevated pressure of at least 0.5 MPa and an elevated temperature of at least 100° C.

Preferably, the treatment in step iii) is carried out at a pressure in the range of from 0.5 to 10.0 MPa (5 to 100 bar), particularly preferably from 1.5 to 8.0 MPa.

Preferably, the treatment in step iii) is carried out at a temperature in the range of from 100 bis 350° C., particularly preferably from 120 to 330° C., in particular from 150 to 320° C.

Preferably, the treatment in step iii) is carried out in a press over a period of time of from 5 seconds to 5 minutes, preferably from 10 seconds to 2 minutes.

Preferably, the treatment in step iii) is carried out in a calender over a period of time of from 0 seconds to 10 seconds, preferably from 0.1 seconds to 5 seconds.

The post-treatment in step iii) can be performed using conventional devices, such as single daylight and multi-daylight presses, continuous belt presses, or calenders. In an embodiment, the post-treatment in step iii) is carried out using at least one double belt press. In some embodiments, the post-treatment in step iii) is carried out using at least one calender.

Single and multi-daylight presses are especially suitable for discontinuous post-treatment of sectioned materials. Double belt presses are suitable for both continuous web materials and sectioned materials (plate material). Double belt presses have two circulating endless belts between which the GDL web is post-treated under pressure and possibly also heat while being transported in the direction of forward travel. The belts are aligned parallel to each other, with a gap between the upper belt and the lower belt. The gap can be opened and closed for adjustment to the thickness of the GDL material and to obtain the desired properties.

In an embodiment, the treatment in step iii) is carried out in a double belt press. Specifically, the treatment in step iii) is carried out in a double belt press at a pressure in the range of from 1 to 8 MPa (10 to 80 bar) and at a temperature in the range of from 200 to 350° C.

In principle, known commercially available calenders can be used in step iii) of the method according to the present disclosure. For instance, it is possible to employ calenders having 2, 3, 4, or more than 4 calender rolls. In an embodiment, the calender used in the method according to the present disclosure is a two-roll calender. The gas diffusion layer may be passed through the calender once or repeatedly, such as 1, 2, 3, 4, 5, or more than 5 times. The calender rolls can be arranged in a geometry that is suitable for calendering the gas diffusion layers. A two-roll calender can have a vertical, oblique, or horizontal arrangement of the rolls. A three-roll calender can have a vertical arrangement, an offset upper roll, or an offset lower roll. A four-roll calender can have an “L” arrangement, an inverted “L” arrangement, an “S” arrangement, a “Z” arrangement, or a different arrangement of the rolls.

Preferably, the treatment in step iii) is carried out in a calender at a nip pressure in the range of from 5 to 500 N/mm, preferably from 10 to 100 N/mm.

Preferably, the calendering in step iii) is carried out at a speed of from 0.05 m/min to 30 m/min.

In an embodiment, the treatment in step iii) is carried out in a calender. Specifically, the treatment in step iii) is carried out in a calender at a roll temperature in the range of from 130 to 220° C., at a nip pressure in the range of from 8 to 80 N/mm, and a web speed of from 1 to 10 m/min.

### Flat, Electrically Conductive Fiber Material A) and Gas Diffusions Layer (GDL)

In the context of the present disclosure, the term “fibrous web” refers generally to a web material that is composed, for the most part, of individual fibers which are held together only by their own adhesion. The conversion of a fibrous web into a non-woven fabric is accomplished by creating a stronger bond between the fibers than that present in the fibrous web. This is done using web consolidation techniques, which are typically classified into mechanical, chemical, and thermal techniques. Fibrous webs, non-woven fabrics, and methods for the production thereof are described in “Vliesstoffe” [Nonwoven Fabrics], edited by W. Albrecht, H. Fuchs, and W. Kittelmann, 2^{nd} edition, Wiley-VCH, Weinheim, Germany.

The flat, electrically conductive fiber material A) and the gas diffusion layer used in accordance with the present disclosure are sheet-like structures having a substantially two-dimensional extent and a small thickness relative thereto. The gas diffusion layer according to the present disclosure has a planar area which typically corresponds substantially to the planar area of the adjacent membrane with the catalyst layers and to the planar area of the adjacent flow distribution plate. The shape of the planar area of the gas diffusion layer may be, for example, polygonal (n-sided, with n≥3, e.g., triangular, rectangular, pentagonal, hexagonal, etc.), circular, circular segment-shaped (e.g., semicircular), ellipsoid or elliptical segment-shaped. Preferably, the planar area is rectangular or circular. A Cartesian coordinate system can be used to describe the GDL, the planar area of the GDL extending in the plane defined by the x-axis and the y-axis (also referred to as the x-y plane). The z-axis orthogonal thereto is used to describe the material thickness. According to the usual description of fiber composite materials, the x-axis is also described as the machine direction (MD) and the y-axis is described as the cross-machine direction (CMD). The material transport between the flow distribution plate and the membrane is substantially in the direction of the z-axis.

The gas diffusion layer includes, as a component A), at least one electrically conductive flat fiber material. Preferably, component A) includes a fiber material selected from non-woven fabrics, papers, fabrics, and combinations thereof. Suitable substrate materials are fiber materials which are conductive themselves or have been made conductive by the addition of conductive additives, such as carbon or metal particles. In principle, carbon fibers, glass fibers, fibers of organic polymers, such as polypropylene, polyester, polyphenylene sulfide, polyetherketones, and mixtures thereof are suitable as a substrate material. The fibers contained in fiber material A) preferably include or are composed of carbon fibers. Such fiber materials particularly advantageously meet the demands placed on the GDL with respect to gas diffusivity, liquid water permeability, electrical and thermal conductivity. Fiber material A) is preferably selected from carbon fiber fabrics, carbon fiber papers, and carbon fiber non-woven fabrics. In an embodiment, fiber material A) includes at least one carbon fiber non-woven fabric or is composed of a carbon fiber non-woven fabric.

The production of the carbon fibers can be performed in the usual manner, with polyacrylonitrile fibers (PAN fibers) being preferably used as the starting material. PAN fibers are produced by radical polymerization of a monomer composition that preferably contains at least 90 percent by weight of acrylonitrile, based on the total weight of the monomers used for polymerization. The polymer solution obtained is spun to filaments and combined into ropes by, for example, wet spinning and coagulation. Before this PAN precursor is converted to carbon fibers under high temperatures, it is usually subjected to oxidative cyclizing (also referred to as oxidation, in short) in an oxygen-containing atmosphere at elevated temperatures of about 180 to 300° C. The resulting chemical cross-linking improves the dimensional stability of the fibers. Subsequently, the actual pyrolysis to carbon fibers is performed at temperatures of at least 1200° C. Depending on the shape of the desired fiber material, either the initial fibers or an already flat fiber material can be used for this pyrolysis. Depending on the temperature during pyrolysis, a distinction is made between carbonization and graphitization. Carbonization is a treatment at about 1200 to 1500° C. under an inert gas atmosphere leading to the release of volatile products. Graphitization, i.e., heating to about 2000 to 3000° C. under an inert gas, yields so-called high-modulus or graphite fibers. These fibers are of high purity, high strength, are light in weight, and have excellent conductivity of electricity and heat.

Fiber material A) is preferably selected from carbon fiber fabrics, carbon fiber papers, and carbon fiber non-woven fabrics.

In the case of carbon fiber fabrics, the flat fiber material is produced by crossing two thread systems, warp (warp threads) and weft (weft threads). As in textiles, fiber bundles are flexibly but inseparably joined. To produce carbon fiber fabrics, preferably oxidized but not yet carbonized or graphitized PAN fibers are used. The carbonization or graphitization is performed after weaving to make the flat fiber material electrically conductive.

As described at the outset, oxidized PAN fibers are commonly used for the production of carbon fiber papers. These PAN fibers are broken in a generally known manner into fiber fragments, suspended in water and, in an analogous fashion to paper making, a fiber layer is produced by screening and dried. In an embodiment, at least one binder is additionally introduced into the paper. Suitable binders are, for example, phenolic, furan, polyimide resins, etc. To introduce the binder, the paper can be impregnated therewith, and, as the case may be, the binder can be subsequently cured. After impregnation and curing, the carbon fiber paper is subjected to another carbonization/graphitization process, to also convert the binder to compounds having improved electrical conductivity. In an embodiment, a filled carbon fiber paper is used to provide fiber material A). The production is initially similar to the one described above, but instead of introducing a binder and carbonizing/graphitizing it, a filler composed of a carbon material in a polymeric binder is introduced into the still-wet paper. In particular, a carbon/PTFE filler is used. By this filling, the thermal and electrical conductivity is sufficiently increased so that the carbonization/graphitization step can be omitted.

To produce carbon fiber non-woven fabrics, non-oxidized or oxidized PAN fibers can be used. In a first step, they can be laid (carded) in a dry state to form a web and subsequently consolidated to form a non-woven fabric. This can be done, for example, by hydroentangling, in which the carbon fibers are oriented, entangled, and thus mechanically stabilized. If necessary, the thickness of the consolidated non-woven fabric can be calibrated to a desired value. In the case of non-woven fabrics based on non-oxidized PAN fibers, after laying and consolidating the non-woven fabrics, they are initially oxidized at elevated temperature under an oxygen atmosphere and subsequently carbonized/graphitized under an inert gas atmosphere. Non-woven fabrics based on oxidized PAN fibers are only subjected to carbonization/graphitization after laying and consolidating the non-woven fabric. Optionally, at least one binder may be introduced into the non-woven fabric and, possibly, subsequently be cured. Suitable binders are those mentioned for carbon fiber papers, specifically phenolic resins. The binder can be introduced, for example, after the carbonization/graphitization, and the resulting impregnated non-woven fabric can finally be carbonized/graphitized again.

In an embodiment, the flat, electrically conductive fiber material A) includes at least one carbon fiber non-woven fabric. Carbon fiber non-woven fabrics are advantageous, inter alia, because they are compressively resilient and can be easily produced on an industrial scale, for example, in a roll-to-roll process.

Fiber material A) is usually a fiber composite material including:
a1) carbon fibers,
a2) possibly, at least one polymeric binder and/or a pyrolysis product thereof,
a3) possibly, at least one further additive different from a2).

The fiber materials A) contained in the gas diffusion layer may contain common additives a3). These are preferably selected from hydrophobizing agents, conductivity-enhancing additives, surface-active agents, and mixtures thereof.

To improve the transport processes through the GDL and at the interfaces, it may be advantageous to increase the hydrophobicity of fiber material A). Suitable hydrophobizing agents are fluorine-containing polymers, such as polytetrafluoroethylene (PTFE) and tetrafluoroethylene-hexafluoropropylene copolymers (FEP). Preferably, PTFE is used as the hydrophobizing agent. The fiber material can be treated with the hydrophobizing agent using conventional impregnating techniques. For this purpose, a PTFE dispersion can be applied in a dipping bath, the solvent can be evaporated, and the treated fiber material can be sintered at elevated temperatures of usually at least 300° C.

Preferably, fiber material A) has a hydrophobizing agent content of 3 to 40 wt %, based on the total weight of fiber material A). In an embodiment, the fiber material has a PTFE content of 3 to 40 wt %, based on the total weight of fiber material A).

To improve the electrical and thermal conductivity, fiber material A) can be finished with at least one conductivity-enhancing additive. Suitable conductivity-enhancing additives are, for example, metal particles, carbon particles, etc. Preferably, the conductivity-enhancing additive is selected from carbon black, graphite, graphene, carbon nanotubes (CNT), carbon nanofibers, and mixtures thereof. The finishing of fiber material A) with at least one conductivity-enhancing additive can be performed, for example, together with the hydrophobizing agent, especially a PTFE dispersion. Often, fiber material A) has good electrical and thermal conductivity due to the carbon fibers used, even without the use of conductivity-enhancing additives.

Preferably, fiber material A) has a conductivity-enhancing additive content of 0 to 40 wt %, based on the total weight of fiber material A). If fiber material A) contains a conductivity-enhancing additive, it is preferably present in an amount of 0.1 to 40 wt %, particularly preferably of 0.5 to 30 wt %, based on the total weight of fiber material A).

Fiber material A) preferably has a thickness in the range of from 50 to 750 μm, particularly preferably from 100 to 500 μm. This thickness refers to the uncompressed state of fiber material A), i.e., prior to the post-treatment in step iii) and prior to installation of the GDL in a fuel cell.

Fiber material A) preferably has a porosity in the range of from 10 to 90%, particularly preferably from 20 to 85%, measured using mercury porosimetry according to DIN ISO 15901-1:2019-03.

The mean pore diameter of fiber material A) is preferably in a range of from 5 to 60 μm, particularly preferably from 8 to 50 μm, in particular from 10 to 40 μm. The mean pore diameter can be determined using mercury porosimetry according to DIN ISO 15901-1:2019-03.

### Microporous Layer B)

The gas diffusion layer according to the present disclosure is composed of a two-layer laminate composite based on a flat, electrically conductive fiber material A) and at least one microporous layer (MPL) B) on at least one of the surfaces of fiber material A).

According to the present disclosure, microporous layer B) includes conductive particles in a matrix of a polymeric binding agent. The conductive particles are preferably selected from conductive carbon particles, in particular carbon black, graphite, graphene, carbon nanotubes (CNT), carbon nanofibers, and mixtures thereof. Preferably, carbon black, graphite, or a mixture thereof is used.

The polymeric binding agent contains at least one fluorine-containing polymer. The fluorine-containing polymer is preferably selected from polytetrafluoroethylenes, tetrafluoroethylene-hexafluoropropylene copolymers, and mixtures thereof. Preferably, a polytetrafluoroethylene (PTFE) is used.

To produce the microporous layer B), the polymeric binding agent is preferably used in an amount, by weight, of from 0.5 to 50 wt %, particularly preferably from 1.0 to 40 wt %, in particular from 10 to 25 wt %, based on the total weight of the polymeric binding agents and conductive particles.

In contrast to macroporous fiber material A), MPL B) is microporous, with pore diameters which are usually significantly below one micrometer, preferably no greater than 900 nm, particularly preferably no greater than 500 nm, in particular no greater than 300 nm. The mean pore diameter of MPL B) is preferably in a range of from 5 to 200 nm, particularly preferably from 10 to 100 nm.

The porosity and the pore size distribution can be determined using mercury porosimetry as specified in DIN ISO 15901-1:2019-03: Mercury Porosimetry. The last-mentioned mean pore diameters are applicable, in particular, to the use of carbon black as conductive particles in the MPL. Significantly larger MPL pores can be created by the use of graphite as conductive particles in the MPL or the use of pore-forming agents. Depending on the composition, the mean pore diameter will be larger than, for example, 1 μm. When various conductive particles are used, the pore diameter can have a bimodal or polymodal distribution curve. The use of a mixture of carbon black and graphite can thus create a pore diameter distribution with two pore peaks (one carbon-black peak and one graphite peak).

Microporous layer B) preferably has a thickness in the range of from 5 to 150 μm, particularly preferably from 10 to 100 μm. This thickness refers to the uncompressed state of microporous layer B), i.e., prior to the post-treatment in step iii) and prior to installation of the GDL in a fuel cell.

The presence of the MPL has a substantial influence on the water management of the fuel cell. Due to the high PTFE content and the smaller pores of the MPL, flooding of the GDL and the electrode is impeded by the MPL acting as a liquid water barrier and thus promoting mass transport of the gaseous reactants to the catalyst.

The gas diffusion layer according to the invention preferably has a thickness (total thickness of fiber material A) and MPL B)) in the range of from 50 to 1000 μm, particularly preferably from 75 to 500 μm. This thickness refers to the uncompressed state of the GDL, i.e., prior to the post-treatment in step iii) and prior to its installation in a fuel cell.

Furthermore, the gas diffusion layers preferably have a high total porosity, which is preferably in the range of from 20% to 80%, and which, as described earlier, is measured using mercury porosimetry according to DIN ISO 15901-1:2019-03.

### Method for Producing a Gas Diffusion Layer

### Step I)

As for the suitable and preferred fiber materials A) used in step i), reference is made to the above explanations in their entirety.

### Step II)

The precursors used in step ii) preferably contain at least one fluorine-containing polymer, at least one carbon material and, possibly, at least one pore-forming agent. The fluorine-containing polymers are preferably selected from polytetrafluoroethylene (PTFE) and tetrafluoroethylene-hexafluoropropylene copolymers (FEP). Preferably, PTFE is used. Preferably, the carbon material is selected from carbon black, graphite, graphene, carbon nanotubes (CNT), carbon nanofibers, and mixtures thereof. Preferably, carbon black or graphite is used. In an embodiment, the precursors used in step b) preferably contain at least one pore-forming agent. Suitable pore-forming agents are commercially available plastic particles, e.g., of polymethyl methacrylate (PMMA). A suitable particle size is in the range of from 10 to 100 μm.

Preferably, the volume fraction of the pores in the finished microporous layer, which is due to the use of a pore-forming agent, is from 0 to 70% by volume, based on the total volume of pores in the finished microporous layer.

The application of the MPL can be done in different ways. While spraying, screen-printing, or Meyer rod techniques are often used in discontinuous production, doctor-blade, slot-die and gravure roll processes are used in continuous coating. The MPL layer thickness and the penetration depth can be controlled by the coating process parameters and the viscosity of the coating. Finally, another thermal treatment is carried out, for example in a drying and sintering furnace. This can be done by first drying at a temperature from 100 to 200° C. and subsequently sintering at a temperature of 300 to 500° C.

With regard to post-treatment step iii), reference is made here to the above detailed description thereof.

### Compression Set Value:

The term “plastic deformation” is used when a material, such as a gas diffusion layer, that does not return one hundred percent to its original shape after being loaded, but some permanent deformation will remain. A portion of the deformation is elastic and thus reversible, and only a certain portion is plastic and permanent. The property of a material to permanently change its shape when subjected to stress, i.e., its deformability, is also referred to by the term “setting.” Materials with low plastic deformability have a low setting behavior.

The compression set value is a measure of how a material, in this case a GDL, behaves during compression deformation and subsequent relaxation. GDLs are generally strongly compressed when used in fuel cells. The properties of a GDL resulting from compression can be characterized by the proportion of elastic and plastic deformation. The compression set is the permanent deformation that remains after the acting force is removed. Gas diffusion layers with a low setting behavior are characterized by low compression set values. The compression set value can be determined as follows. The values of other physical quantities, such as thickness, gas permeability, electrical resistance, can be determined simultaneously, at a specific compressive force and after a single or repeated application of force.

Three samples (left, right and, center) are taken from the GDL to be tested across the entire width, from which an average value is calculated. If the material has a machine direction due to the production process, the samples are taken perpendicular to the machine direction (CMD). The samples have an annular shape with an inner diameter of 45 mm and an outer diameter of 56 mm. The sample surface area is 8.72577 cm². In a testing machine, the samples are subjected to a time-varying compressive force that acts vertically on the surface of the sample. A sensor determines the change in thickness of the GDL over time at the respective acting pressure. The sample is supported on a device for determining the elastic and plastic deformation by means of force sensors, the movement being transmitted to the sample via springs. The distance traveled until the maximum compressive force is reached is determined by displacement sensors. Since the deformation of the sample is non-linear, the course of the measurement is adapted to the relative change. One measurement cycle, i.e., a single loading until the maximum pressure is reached, lasts about 1 min. The sample undergoes three load cycles. The initial value, at which only a small force is applied to the sample, is 0.025 MPa. Typical pressure values used in determining the compression set value (and other physical quantities, such as thickness, electrical conductivity or sheet resistance, gas permeability, etc.) are, for example, 0.6 MPa, 1.0 MPa, and 2.4 MPa.

The compression set value for a specific pressure is calculated from the difference between the thickness measured at this pressure in the first load cycle and the thickness measured at this pressure in the third load cycle.

Preferably, the GDL according to the present disclosure has a compression set value of no greater than 5 m at 10 bar (1 MPa), measured using the above-described method on an annular sample having an inner diameter of 45 mm and an outer diameter of 56 mm on a GDL having a weight per unit area of from 90 to 95 g/m and an MPL loading of from 15.0 to 22.0 g/m².

### Roughness:

The roughness can be determined using conventional profile methods known to those skilled in the art, such as are described in DIN 4768-1:1974-08, entitled “Determination of Surface Roughness Rₐ, R_{z}, Rₘₐₓ with Electric Stylus Instruments; Basic Data.”

The parameters determined were the average roughness Rₐ (average distance of a measuring point on the surface from the centerline) and the mean peak-to-valley height R_{z}. The measurements were performed using a Mahrsurf XCR20 measuring instrument with a MFW-250 contact stylus available from the Mahr company. The values are average values obtained from 6 measurements: 3 in the machine direction (MD) and 3 perpendicular to the machine direction (CD). The specific measurement conditions are described in the Examples Section, to which reference is made here.

### Puncture Test, Shorting Number:

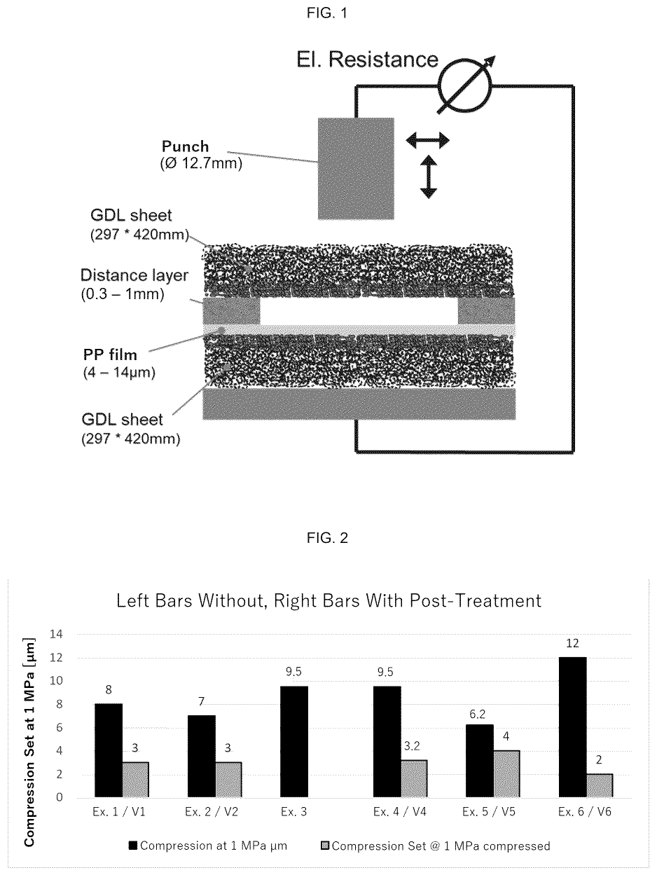

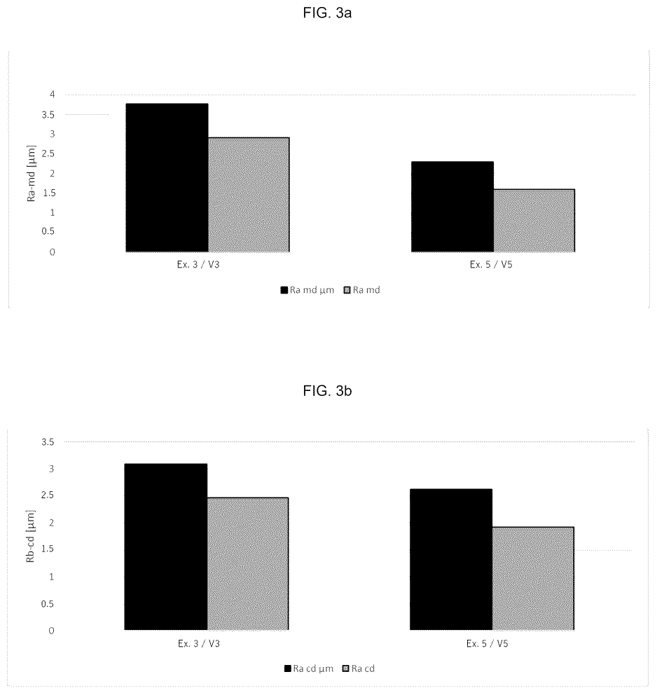

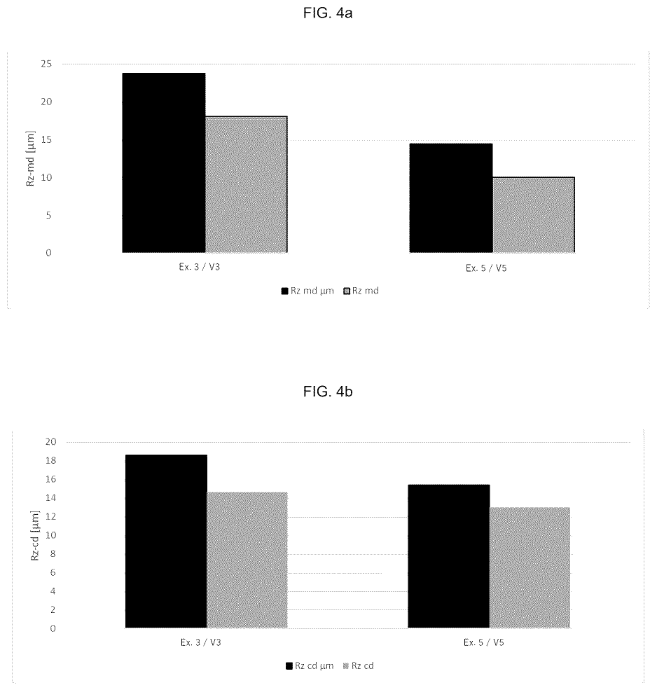

FIG. 1 shows a puncture testing device for determining the shorting number as a measurement value characterizing the probability of a short circuit.

In the puncture test, a PP film (thickness: 4 μm) is placed between two GDL sheet samples and a distance layer with a defined thickness (0.1 to 1.0 mm) and defined gaps. The materials lie on an electrically conductive smooth metal plate. During testing, a metal punch (diameter: 12.7 mm) presses the upper GDL slowly into the gap of the distance layer and onto the PP film. The electrically conductive punch and the metal plate are connected to a resistance measurement device. The measurement at the test point is completed when the maximum pressure is reached. A puncture in the PP film is present when the resistance falls below the threshold of 10 kΩ. The associated pressure is recorded. Since the GDL itself is conductive, this measurement detects damage to the PP film caused by the indented GDL. Typically, 117 measuring points over an area of about 300×400 mm are approached in one measurement cycle.

Tests performed on PP films of different thickness (4-14 μm) further showed that the probability of the film/membrane being punctured increases with decreasing thickness of the PP films and that the number of punctures increases after a certain number of measurements with the same material/measurement parameter combination. At least 117 measurements (standard: 4 cycles of 177 measurements each) are performed for each combination.

The shorting number as a measurement value characterizing the probability of a short circuit is defined as follows:

shorting number=(number of punctured measuring points/total number of measuring points)×100.

In other words, the shorting number is defined as the percentage ratio between the number of measurements where the resistance is below the threshold and the total number of measurements. The lower the number of measurements where the resistance is below the threshold, the lower the shorting number and the lower the probability of penetration of the membrane.

Preferably, the gas diffusion layer according to the invention has a shorting number of no greater than 15%, determined by a puncture test on a GDL having a planar area of 297×420 mm, a weight per unit area of 95 g/m², and an MPL loading of 15 g/m².

The specific measurement conditions are described in the Examples Section, to which reference is made here.

### Other Physical Quantities:

The through-plane gas permeability can be determined by means of a Gurley measurement, for which an automated Gurley densometer from Gurley Precision Instruments can be used. In the measurement, the time in seconds is determined until 100 cm³ of air have passed perpendicularly through a GDL sample with a flow-through area of 6.42 cm² at a constant pressure differential. The determination of the Gurley air permeability is described in ISO 5636-5.

The dry diffusion length refers to the actual length of the distance in m that a gas molecule travels through flat fiber material A) and/or microporous layer B). It is determined using a stationary Wicke-Kallenbach cell.

The thickness of the gas diffusion layer can be determined according to DIN 53855-1:1993-08: “Determination of the Thickness of Textile Fabrics.” The determination of the thickness at a specific compressive force (e.g., at 0.025 MPa or at 1.0 MPa) can be performed in a compression set measuring device, as previously described in detail.

The mass per unit area in g/m2 can be determined according to EN 29073-1:1992.

The porosity of the GDL can be determined using mercury porosimetry as specified in DIN ISO 15901-1:2019-03: Mercury Porosimetry.

### Fuel Cell

An embodiment of the present disclosure includes a fuel cell including at least one gas diffusion layer as defined herein or obtainable by a method as described herein.

The gas diffusion layer of the present disclosure is suitable for all types of fuel cells. The fuel cell according to the present disclosure is preferably a proton exchange membrane fuel cell (PEMFC). Proton exchange membrane fuel cells also referred to as polymer electrolyte fuel cells (PEFC) or low-temperature polymer electrolyte membrane fuel cells (LT-PEMFC). An embodiment of the present disclosure resides in hydrogen-oxygen fuel cells in the form of low-temperature proton exchange membrane fuel cells (PEMFC). As for the configuration of fuel cells, reference is made to the above explanations in their entirety.

The fuel cells according to the present disclosure preferably include a polymer electrolyte membrane having a catalyst layer deposited on the anode and cathode sides thereof, forming the electrodes. Preferably, a gas diffusion layer (GDL) is in contact with the catalyst layer on the anode side and/or the cathode side. Specifically, the fuel cells have a polymer electrolyte membrane with a catalyst layer deposited thereon, the catalyst layer being in contact with the surface of the microporous layer B) of a gas diffusion layer according to the present disclosure. Specifically, the fuel cells have an inventive gas diffusion layer on the cathode side, the catalyst layer being in contact with the surface of the microporous layer B) of the gas diffusion layer. More specifically, the fuel cells have a novel gas diffusion layer on the cathode side and on the anode side, both the cathode layer and the anode layer being in contact with the surface of the microporous layer B) of a gas diffusion layer according to the present disclosure.

It is an advantage of the present disclosure that the transport processes through the gas diffusion layer can be specifically adjusted to the gradients of the operating media flowing through the fuel cell and/or the operating parameters of the fuel cell. For this purpose, usually at least one property gradient of the gas diffusion layer corresponds with at least one of the property gradients of the operating media flowing through the fuel cell and/or the operating parameters of the fuel cell.

An embodiment of the present disclosure includes the use of a gas diffusion layer as described herein or obtainable by a method as described herein in a proton exchange membrane fuel cell.

The following examples serve to illustrate the invention without limiting it in any way.

### EXAMPLES

### I) Production of a Gas Diffusion Layers

### Production Example 1

Production of a gas diffusion layer without (Example V1) and with post-treatment (Example 1) according to embodiments of the present disclosure at elevated pressure and elevated temperature.

A non-woven fabric made of 100% carbon fibers with a weight per unit area of 100 g/m² was used to produce a flat, electrically conductive material. An impregnating composition containing 80% carbon black and 20% PTFE, based on the solids content, was mixed to finish the non-woven fabric. The finishing was done by padding impregnation with an aqueous dispersion with a finish weight of 15%, based on the mass of the GDL substrate (corresponding to 15 g/m²). This was followed by drying at 80° C. for 2 minutes and sintering at 400° C. for 2 minutes. In addition, an MPL was deposited on the substrate so obtained to produce the gas diffusion layers. For the MPL coating, an MPL paste containing 2 wt % of PTFE and 7.8 w % of carbon in distilled water was applied to the fiber material. The fiber material was then dried at 160° C. for 2 minutes and sintered at 400° C. for 2 minutes. The resulting MPL loading was 15 g/m². The GDLs according to the present disclosure were subjected to a post-treatment in a double belt press at a pressure of 25 bar and a temperature of 320° C. for 20 s. The non-post-treated GDL is presented for comparative purposes.

### II) Practical Examples

The following materials were used to determine the operational properties:
1) Example 1/V1
   GDL from production example 1
2) Example 2/V2
   GDL similar to production example 1 with a weight per unit area of 100 g/m2.
3) Example 3/V3
   GDL similar to production example 1 with a weight per unit area of 132 g/m2.
4) Example 4/V4
   GDL similar to production example 1 with a weight per unit area of 135 g/m2.
5) Example 5/V5
   GDL similar to production example 1 with a weight per unit area of 96.5 g/m2.
6) Example 6/V6
   GDL similar to production example 1 with a weight per unit area of 94 g/m2.

### Compression Set

The compression set values and thicknesses were determined using the method described in detail above. The values are shown in Table 1 below.

### Roughness

The roughness was determined using the profile method as described in DIN 4768-1:1974-08.

The parameters determined were the average roughness Rₐ (average distance of a measuring point on the surface from the centerline) and the mean peak-to-valley height R_{z}. The measurements were performed using a Mahrsurf XCR20 measuring instrument with a MFW-250 contact stylus available from the Mahr company. The values are average values obtained from 6 measurements: 3 in the machine direction (MD) and 3 perpendicular to the machine direction (CD).

The following conditions were selected for the measurement:
Contact stylus=MFW-250. Stylus diamond radius 2 μm, cone angle 60°
LC (GS)=2.5 mm=cut off=LT+LM
LT=17.5 mm=traversing length=2.5 mm pre-travel length and 2.5 mm post-travel length for initial and relaxation oscillations of the Gaussian filter. This length of 2×2.5 mm is not considered in the measurement.
LM=12.5 mm=measuring length that leads to the determination of the roughness value
Z=5=number of individual measurements for the Rz value. The measuring path (profile) is divided into 5 symmetrical separate sections (=LM/5). An average value is calculated from each section. The Rz value is calculated as the mean from the 5 average values.
VB=+−250 μm=measuring range of the contact stylus
Profile resolution per measuring length=100,000 steps
Linearity=<1%
Contact force (measuring force)=0.8 mN
Tracing speed 0.5 mm/s

### Puncture Test, Shorting Number:

The puncture test for determining the shorting number was carried out as previously described in detail. 117 measuring points over an area of about 300×400 mm were approached in one measurement cycle. The results can be seen from Table 1.

The Gurley gas permeability was be determined according to ISO 5636-5 using a Gurley densometer from Gurley Precision Instruments. The results can also be seen from Table 1.

The dry diffusion length was determined using a stationary Wicke-Kallenbach cell. The results can also be seen from Table 1.

TABLE 1

| | | Example | | | | | | | | | | | |
|---|---|---|---|---|---|---|---|---|---|---|---|---|---|
| Property | Unit | V1 | 1 | V2 | 2 | V3 | 3 | V4 | 4 | V5 | 5 | V6 | 6 |
| Post-treatment at | | no | yes | no | yes | no | yes | no | yes | no | yes | no | yes |
| elevated p, t | | | | | | | | | | | | | |
| Thickness at | μm | 250 | 230 | 180 | 170 | 247 | 235 | 250 | 220 | 162 | | 190 | 170 |
| 0.025 MPa | | | | | | | | | | | | | |
| Thickness at | μm | 210 | 200 | 150 | 141 | 215 | | 213 | 200 | 146 | 134 | 150 | 145 |
| 1 MPa | | | | | | | | | | | | | |
| Weight per unit | g/m² | 135 | 135 | 100 | 97 | 132 | 132 | 134.5 | | 96.5 | | 94 | 94 |
| area | | | | | | | | | | | | | |
| Compression set at | μm | 8 | 3 | 7 | 3 | 9.5 | | 9.5 | 3.2 | 6.2 | 4 | 12 | 2 |
| 1 MPa (difference | | | | | | | | | | | | | |
| 1^{st}/3^{rd} cycle) | | | | | | | | | | | | | |
| Gurley gas | s | 2 | 70 | 30 | 70 | 37.4 | 67 | 30 | 63.5 | 31 | 57.5 | 65 | 85 |
| permeability | | | | | | | | | | | | | |
| Dry diffusion | μm | 700 | 800 | 640 | 640 | | | 833 | 842 | 593 | 618 | 602 | 623 |
| length | | | | | | | | | | | | | |
| Roughness Rₐ | μm | 2.78 | 1.91 | | 1.79 | 3.77 | 2.90 | | 2.31 | 2.29 | 1.59 | | 1.81 |
| (MD) | | | | | | | | | | | | | |
| Roughness Rₐ | μm | 3.31 | 2.16 | | 1.96 | 3.08 | 2.45 | | 1.89 | 2.62 | 1.92 | | 2.39 |
| (CD) | | | | | | | | | | | | | |
| Roughness R_{z} | μm | 16.85 | 10.98 | | 11.47 | 23.77 | 18.07 | | 13.96 | 14.45 | 10.06 | | 12.2 |
| (MD) | | | | | | | | | | | | | |
| Roughness R_{z} | μm | 18.01 | 12.75 | | 10.98 | 18.62 | 14.65 | | 11.14 | 15.36 | 13.01 | | 13.63 |
| (CD) | | | | | | | | | | | | | |

It should be noted that in Table 1 (MD)=in the machine direction, and (CD) is perpendicular to the machine direction.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1: A method for producing a gas diffusion layer for a fuel cell comprising:
A) a flat, electrically conductive fiber material; and
B) a microporous layer on at least one of the surfaces of the fiber material, the microporous layer including conductive particles in a matrix of a polymeric binding agent,
wherein:
i) the flat, electrically conductive fiber material A) is provided,
ii) the fiber material provided in step i) is coated with a precursor to form the microporous layer,
iii) the coated fiber material obtained in step ii) is subjected to a post-treatment at elevated pressure and/or an elevated temperature.

2: The method as recited in claim 1, wherein the gas diffusion layer has one or more of the following properties:
a compression set value at 1.0 MPa of no greater than 5 μm, determined on a gas diffusion layer (GDL) having a weight per unit area of from 95 to 100 g/m² and a microporous layer (MPL) loading of from 15 to 22 g/m² on an annular sample having an inner diameter of 45 mm and an outer diameter of 56 mm, the annular sample being subjected to three load cycles of from 0.025 MPa to 1.0 MPa, and the compression set value being calculated from a difference between a thickness measured at 1.0 MPa in a first load cycle and in a third load cycle,
a decrease of at least 10% in average roughness Ra, determined according to a standard using a profile method, compared to a non-post-treated gas diffusion layer,
a decrease of at least 10% in mean peak-to-valley height Rz, determined according to the standard using the profile method, compared to the non-post-treated gas diffusion layer,
a shorting number of no greater than 25%, determined by a puncture test on a gas diffusion layer (GDL) having a planar area of 297×420 mm, a weight per unit area of 95 g/m², and a microporous layer (MPL) loading of 15 g/m2.

3: The method as recited in claim 1, wherein the fiber material A) is selected from carbon fiber non-woven fabrics, carbon fiber fabrics, or combinations thereof.

4: The method as recited in claim 1, wherein the treatment in step iii) is carried out at a pressure in a range of from 0.5 to 10.0 MPa.

5: The method as recited in claim 1, wherein the treatment in step iii) is carried out at a temperature in a range of from 100 to 350° C.

6: The method as recited in claim 1, wherein the treatment in step iii) is performed using a device selected from daylight presses, multi-daylight presses, continuous belt presses, calenders, or combinations thereof.

7: The method as recited in claim 1, wherein the treatment in step iii) is carried out in a press over a period of time from 5 seconds to 5 minutes.

8: The method as recited in claim 1, wherein the treatment in step iii) is carried out in a calender over a period of time from 0 seconds to 10 seconds.

9: The method as recited in claim 1, wherein the treatment in step iii) is carried out in a calender at a nip pressure in the range of from 5 to 500 N/mm.

10: A gas diffusion layer obtainable by the method as defined in claim 1.

11: A gas diffusion layer for a fuel cell comprising:
A) a flat, electrically conductive fiber material; and
B) a microporous layer on at least one of the surfaces of the fiber material, wherein
the gas diffusion layer has at least one of the following properties:
a compression set value at 1.0 MPa of no greater than 5 μm, determined on a gas diffusion layer (GDL) having a weight per unit area of from 95 to 100 g/m² and a microporous layer (MPL) loading of from 15 to 22 g/m² on an annular sample having an inner diameter of 45 mm and an outer diameter of 56 mm, the annular sample being subjected to three load cycles from 0.025 MPa to 1.0 MPa, and the compression set value being calculated from a difference between a thickness measured at 1.0 MPa in a first load cycle and in a third load cycle,
a decrease of at least 10% in the average roughness Ra, determined according to a standard using a profile method, compared to a non-post-treated gas diffusion layer,
a decrease of at least 10% in mean peak-to-valley height Rz, determined according to the standard using the profile method, compared to the non-post-treated gas diffusion layer,
a shorting number of no greater than 25%, determined by a puncture test on a gas diffusion layer (GDL) having a planar area of 297×420 mm, a weight per unit area of 95 g/m², and a microporous layer (MPL) loading of 15 g/m2.

12: A fuel cell comprising at least one gas diffusion layer as defined in claim 10.

13: The fuel cell as recited in claim 12, comprising a polymer electrolyte membrane having a catalyst layer deposited thereon, the catalyst layer being in contact with a surface of the microporous layer B) of the gas diffusion layer.

14: A proton exchange membrane fuel cell comprising a gas diffusion layer as defined in claim 10.

15: The method as recited in claim 1, wherein the treatment in step iii) is carried out at a pressure in a range from 1.5 to 8.0 MPa.

16: The method as recited in claim 1, wherein the treatment in step iii) is carried out at a temperature in a range of from 120 to 330° C. or from 150 to 320° C.

17: The method as recited in claim 1, wherein the treatment in step iii) is performed using a device selected from double belt presses, calenders, or combinations thereof.

18: The method as recited in claim 1, wherein the treatment in step iii) is carried out in a press over a period of time from 10 seconds to 2 minutes.

19: The method as recited in claim 1, wherein the treatment in step iii) is carried out in a calender over a period of time from 0.1 seconds to 5 seconds.

20: The method as recited in claim 1, wherein the treatment in step iii) is carried out in a calender at a nip pressure in the range of from 10 to 100 N/mm.
